(19) United States
(12) Patent Application Publication
(10) Pub. No.: US 2012/0127218 A1
(43) Pub. Date: May 24, 2012

(54) METHOD AND APPARATUS FOR REDUCING POWER CONSUMPTION IN TERMINAL USING SELF-EMITTING TYPE DISPLAY

(75) Inventor: Yoon-Kook SON, Gyeonggi-do (KR)

(73) Assignee: SAMSUNG ELECTRONICS CO., LTD., Gyeonggi-Do (KR)

(21) Appl. No.: 13/298,517

(22) Filed: Nov. 17, 2011

(30) Foreign Application Priority Data
Nov. 18, 2010 (KR) 10-2010-0114882

(51) Int. Cl. G09G 5/10

(52) U.S. Cl. 345/690

(57) ABSTRACT

A method for reducing power consumption in a terminal having a self-emitting display is provided. In the method, a readable region is displayed on a screen, and a brightness of the rest is made darker than that of the readable region. The readable region is moved.

### CLAIM OF PRIORITY

This application claims the benefit of priority under 35 U.S.C. §119, from Korean patent application Serial No. 10-2010-0114882 filed in the Korean Intellectual Property Office on Nov. 18, 2010, the contents of which are incorporated by reference in its entirety.

### BACKGROUND OF THE INVENTION

1. Field of the Invention

The present invention relates to a method and an apparatus for reducing power consumption in a terminal having a self-luminous display. More particularly, the present invention relates to a method and an apparatus for reducing power consumption without reducing readability when a user views contents such as a web page, an electronic (E)-book, etc.

2. Description of the Related Art

Recently, as a computer innovation continues to rapidly develop and the Internet becomes more and more widely distributed, displays having various shapes and purposes emerge. They are mounted in various devices ranging from a device requiring a large display such as a digital television (TV), a monitor, etc. to a portable device requiring a small and convenient display such as a mobile phone, a Personal Digital Assistant (PDA), etc. Unlike a large-sized device that is typically stationary, since a portable device is supplied with power by a rechargeable battery, it is very important to extend a use time by reducing power consumption of the battery.

Nowadays, a portable device uses a self-emitting display such as a Plasma Display Panel (PDP), an Organic Light Emitting Diode (OLED), Active Matrix Organic LED (AMOLED) etc. These self-emitting displays may provide improved image quality compared to a transmissive display such as a Liquid Crystal Display (LCD). However, the transmissive display consumes constant power regardless of brightness of a display image, but the self-emitting display consumes power proportional to the intensity (brightness) of light of a display image. That is, the self-emitting display requires a relatively large amount of a current in order to display bright light.

Under a circumstance where the contents such as a web page, an E-book, etc. are diversified, a portable device having a self-emitting display requires low power consumption in order to stably supply power.

### SUMMARY OF THE INVENTION

An exemplary aspect of the present invention is to address at least some of the above-mentioned problems and/or disadvantages and to provide at least some of the advantages described below. Accordingly, an exemplary aspect of the present invention is to provide a method and an apparatus for reducing power consumption in a terminal having a self-emitting display.

Another exemplary aspect of the present invention is to provide a method and an apparatus for reducing power consumption without reducing readability while a user views E-book contents in an E-book terminal having a self-emitting display.

The above exemplary aspects are achieved by providing a method for reducing power consumption in a terminal having a self-emitting display according to the present invention as disclosed herein.

In accordance with an exemplary aspect of the present invention, a method for reducing power consumption in a terminal having a self-emitting display is provided. The method includes displaying a readable region on a screen and making a brightness of the rest of the screen darker than that of the readable region, and moving the readable region.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will become more apparent from the following description taken in conjunction with the accompanying drawings in which:

FIG. 1 is a perspective view illustrating a mobile terminal according to an exemplary embodiment of the present invention;

FIG. 2 is a block diagram illustrating an exemplary configuration of a mobile terminal according to an exemplary embodiment of the present invention;

FIG. 3 is a flowchart illustrating an example of a procedure for reducing power consumption in a mobile terminal having a self-emitting display according to an exemplary embodiment of the present invention;

FIG. 4A is a flowchart illustrating a procedure for reducing power consumption in an E-book terminal having a self-emitting display according to an exemplary embodiment of the present invention;

FIG. 4B is a flowchart illustrating a procedure for reducing power consumption in an E-book terminal having a self-emitting display according to an exemplary embodiment of the present invention;

FIGS. 5A to 5C are views illustrating a process of a power save mode in an E-book terminal having a self-emitting display according to an exemplary embodiment of the present invention;

FIGS. 6A to 6C are views illustrating a process of a power save mode in an E-book terminal having a self-emitting display according to an exemplary embodiment of the present invention; and

FIG. 7 is a view illustrating a process of operating a power save mode and displaying a readable region as a page turns in an E-book terminal having a self-emitting display according to an exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the present invention as defined by the claims. The description includes various specific details to assist in that understanding, but these details are to be regarded as merely exemplary. Accordingly, those of ordinary skill in the art will recognize that various changes and modifications of the exemplary embodiments described herein can be made without departing from the scope and spirit of the invention as defined by the appended claims. Also, descriptions of well-known functions and constructions may be omitted for conciseness and so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention as understood by a person of ordinary skill in the art. Accordingly, it should be apparent to those skilled in the art that the following description of exemplary embodiments of the present invention are provided for illustration purpose only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Preferred exemplary embodiments of the present invention will be described below with reference to the accompanying drawings.

The present invention provides a method and an apparatus for reducing power consumption in a terminal having a self-emitting display. More particularly, The present invention provides a method and an apparatus for reducing power consumption without reducing readability when a user views contents such as a web page, an electronic book, etc. The invention is applicable not only to a discrete electronic book or devices used to access web pages, but is also applicable in mobile terminals, tablet computers, PDAs, GPS devices, personal multimedia devices, portable devices, etc., just to name a few non-limiting possibilities. The presently claimed invention can be used with other types of displays, but the self-emitting display is particularly suited for the present invention because of the difference in power consumption.

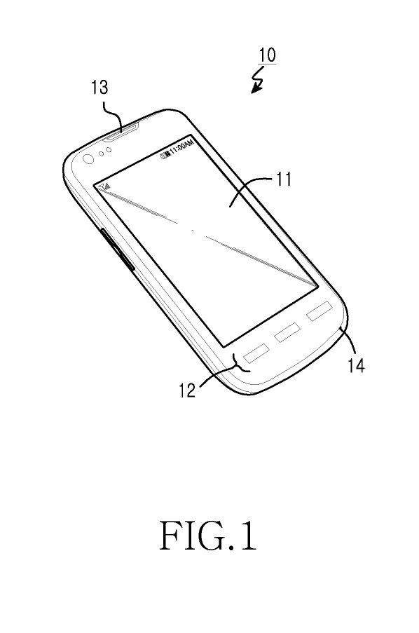

FIG. 1 is a perspective view illustrating a mobile terminal according to an exemplary embodiment of the present invention.

Referring now to FIG. 1, the mobile terminal may be a Personal Digital Assistants (PDA), a cellular phone, tablet display, etc., and display contents such as a web page, an Electronic book (E-book), etc. While the invention is suited for a mobile terminal, the artisan should understand and appreciate that the presently claimed invention is applicable to many other devices in addition to a mobile terminal.

The mobile terminal 10 has a self-emitting display 11 for outputting an image signal, and a keypad 12 serving as a data input unit. The mobile terminal may further include a speaker 13 for outputting a voice signal, and a microphone 14 for receiving a voice signal. The self-emitting display 11 in this particular example may comprise a Plasma Display Panel (PDP), an Organic Light Emitting Diodes (OLED), etc. In the case where a touch screen is provided to the display 11, the display 11 may perform a function of the data input unit as an auxiliary unit or in substitution for the keypad 12. In the following description, it is assumed that the mobile terminal 10 uses a touch screen.

More particularly, the mobile terminal 10 according to an exemplary embodiment of the present invention may reduce power consumption without reducing a user's readability when the user views contents such as a web page, an E-book, etc. Generally, the user views a screen displayed on the display 11 while moving his eyes. For example, when an E-book is driven, the user typically reads displayed writing from left to right and from up to down. At this point, the mobile terminal 10 according to an exemplary embodiment of the present invention may reduce power consumption by relatively lowering the brightness of a screen region on which the user's eyes are not concentrated. The mobile terminal 10 according to an exemplary embodiment of the present invention starts a power save mode to display a readable region on the screen and makes the brightness of the rest darker than that of the readable region. Accordingly, the content of the screen displayed on the readable region is relatively highlighted. The readable region may be moved, and the user may view the content of the contents while moving the readable region. The user may concentrate his eyes on the readable region brighter than the rest. Therefore, the brightness of the readable region may be darker than the brightness of the entire screen before the power save mode operates. Typically, an area of the readable region is less than a viewable area of an entire display screen.

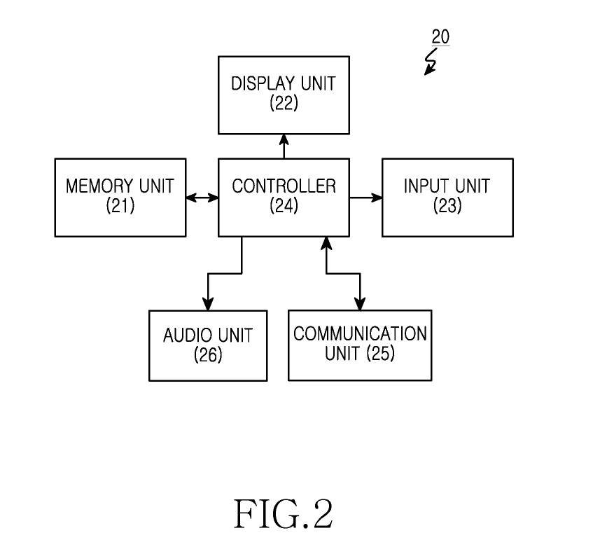

FIG. 2 is a block diagram illustrating a mobile terminal according to an exemplary embodiment of the present invention.

Referring now to FIG. 2, the mobile terminal preferably includes a memory unit 21 for storing object data to be displayed, a display unit 22 for decoding data stored in the memory unit 21 to output an image signal, an input unit 23 for receiving a user input, and a controller 24, which preferably includes at least one of a processor or microprocessor, for performing an overall control of the operation of the mobile terminal. In the event the device comprises a mobile terminal, a communication unit 25 that preferably wirelessly communicates with a base station or server and an audio unit 26 including a microphone and speaker for receiving/outputting audio should be included.

The display unit 22 may be a self-emitting display.

When a power save drive signal is sent from the input unit 23 to the controller, then the controller 24 operates a power save mode. The power save mode displays a readable region on the screen of the display unit 22, and makes the brightness of the rest darker than that of the readable region. When a scroll signal occurs from the input unit 23, the controller 24 moves the readable region to a relevant direction indicated by the scroll signal or a turn signal. In addition, when a screen turn signal (i.e. a turn page signal) occurs from the input unit 23, or a scroll signal that gets out further occurs even after the readable region is moved to the end of the screen, the controller 24 turns display from the current screen page to the previous screen or the next screen page to display the readable region again.

In addition, the controller 24 controls the supply of a current proportional to the intensity of light emitted by the self-emitting display. Therefore, a relatively small amount of a current is supplied to the rest of the display except the readable region. The controller 24 may use, for example, a blending technique based on an alpha reference value as a method for configuring the readable region.

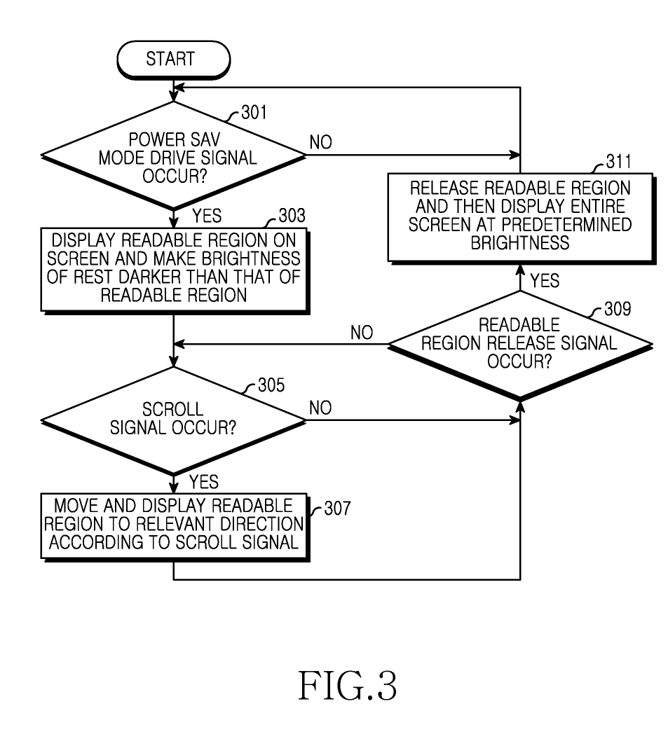

FIG. 3 is a flowchart illustrating a procedure for reducing power consumption in a mobile terminal having a self-emitting display according to an exemplary embodiment of the present invention.

Referring now to FIG. 3, at step 301 the controller 24 determines whether a power save mode drive signal occurs. When the power save mode drive signal occurs, the controller 24 drives a power save mode and the method proceeds to step 303. The power save mode drive signal may occur when a button provided to a touch screen is pressed.

The controller 24 displays a readable region on a screen, and makes the brightness of the rest darker than that of the readable region in step 303. Here, step for controlling the size of the readable region may be further included.

Next, at step 305 the controller 24 determines whether a scroll signal occurs. When the scroll signal occurs, the controller 24 proceeds to perform step 307 to allow the readable region to be moved and displayed in a relevant direction according to the scroll signal. The scroll signal may be generated by a touch movement to a relevant direction or by moving a provided scroll bar to a relevant direction.

In addition, the controller 24 determines at step 309 whether a release signal of the readable region occurs. When the release signal of the readable region occurs, the controller 24 proceeds to perform step 311 to release the readable region and then allow the entire screen to be displayed at a set brightness, and ends the power save mode. The readable region release signal may occur before/after the readable region moves. The readable region release signal may be generated by touching the readable region or the rest.

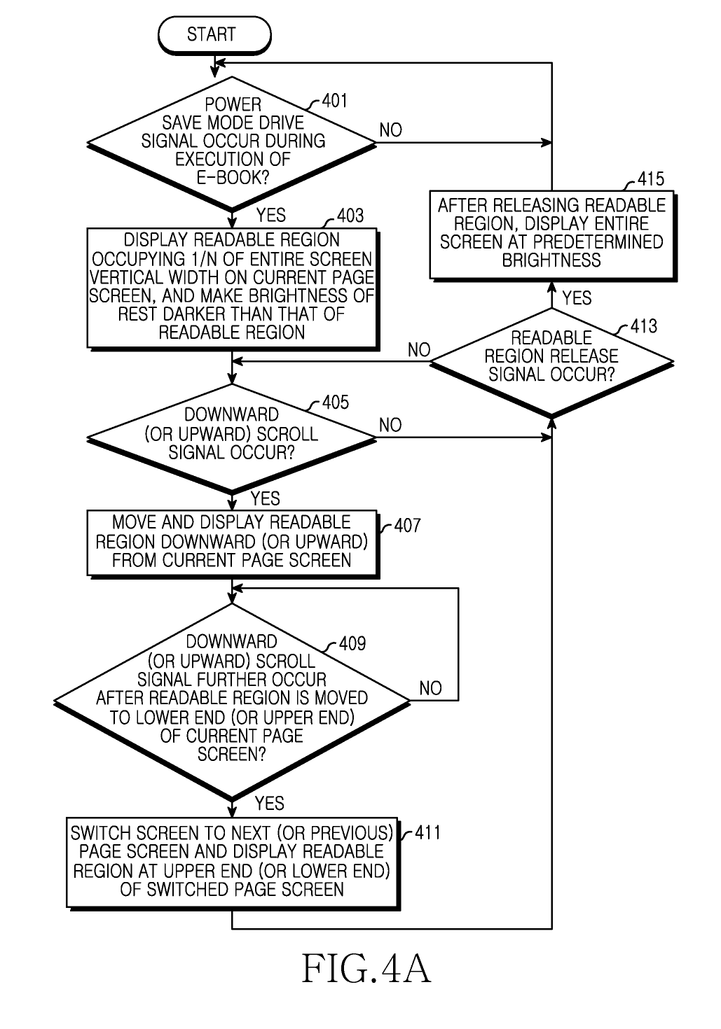

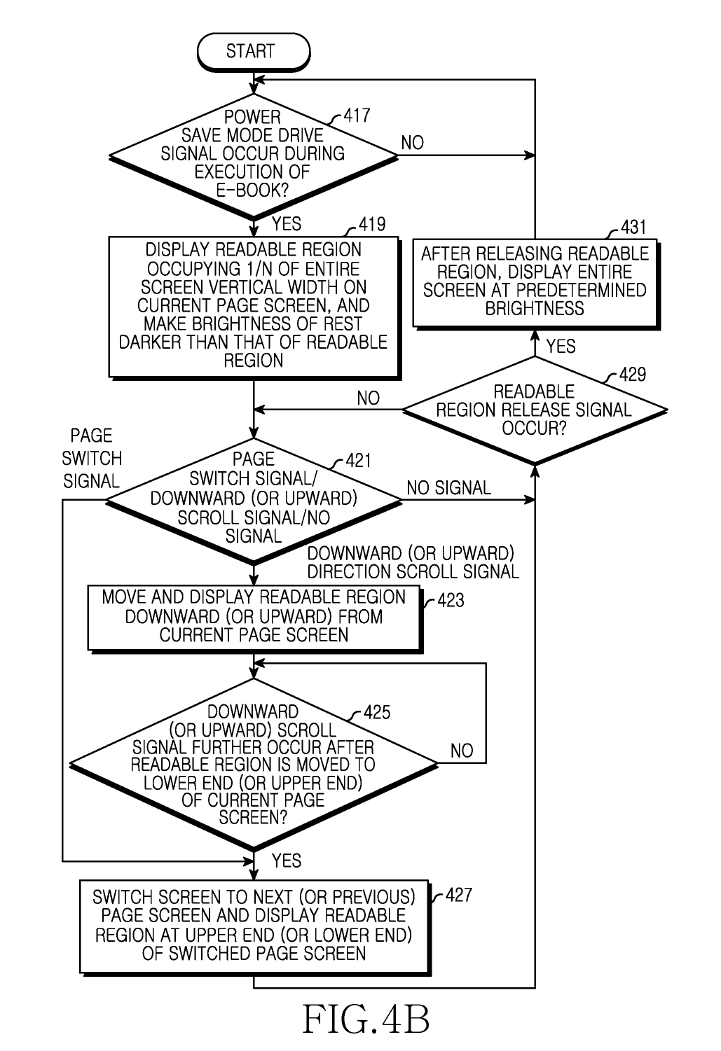

FIG. 4A is a flowchart illustrating a procedure for reducing power consumption in an E-book terminal having a self-emitting display according to an exemplary embodiment of the present invention.

Referring now to FIG. 4A, at step 401 the controller 24 determines whether a power save mode drive signal occurs during execution of an E-book. When the power save mode drive signal occurs, the controller 24 drives the power save mode and proceeds to perform step 403.

At step 403, the controller 24 displays a readable region occupying a 1/n of an entire screen vertical width on a current page screen and allows the brightness of the rest to be displayed darker than that of the readable region.

Next, at step 405 the controller 24 determines whether a downward (or upward) scroll signal occurs. When the scroll signal occurs, the controller 24 allows the readable region in the current page screen to be moved downward (or upward) and displayed.

Next, at step 409 the controller 24 determines whether a downward (or upward) scroll signal further occurs after the readable region in the current page screen is moved to the screen lower end (or upper end).

When the downward (or upward) scroll signal occurs after the readable region in the current page screen is moved to the screen lower end (or upper end), at step 411 the controller 24 turns to the next (or previous) page screen and allows the readable region to be displayed at the upper end (or lower end) of the turned next (or previous) page screen.

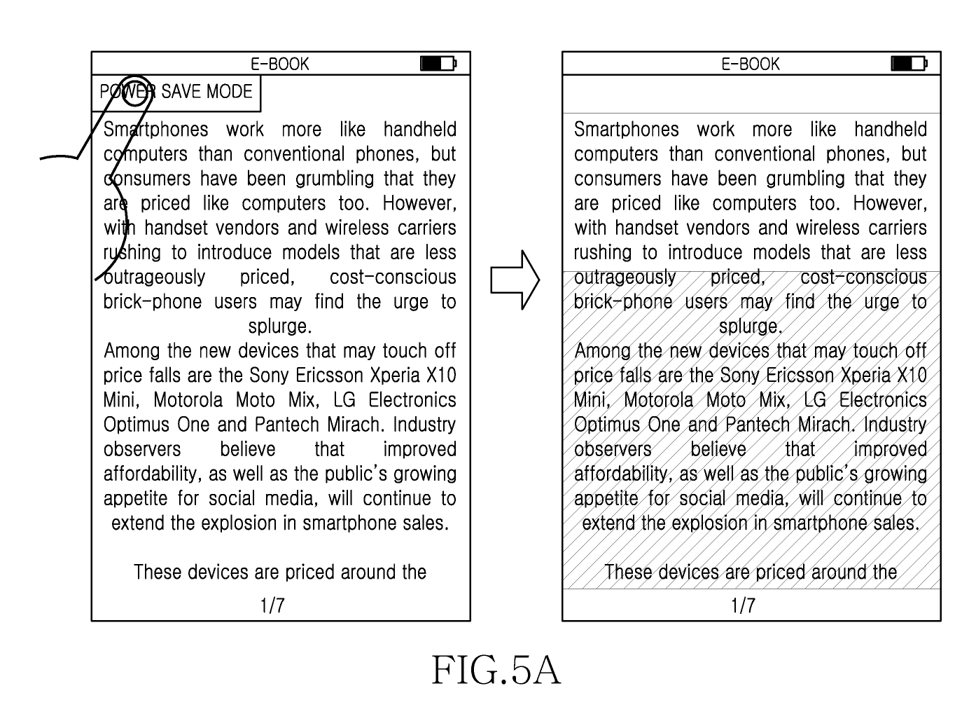

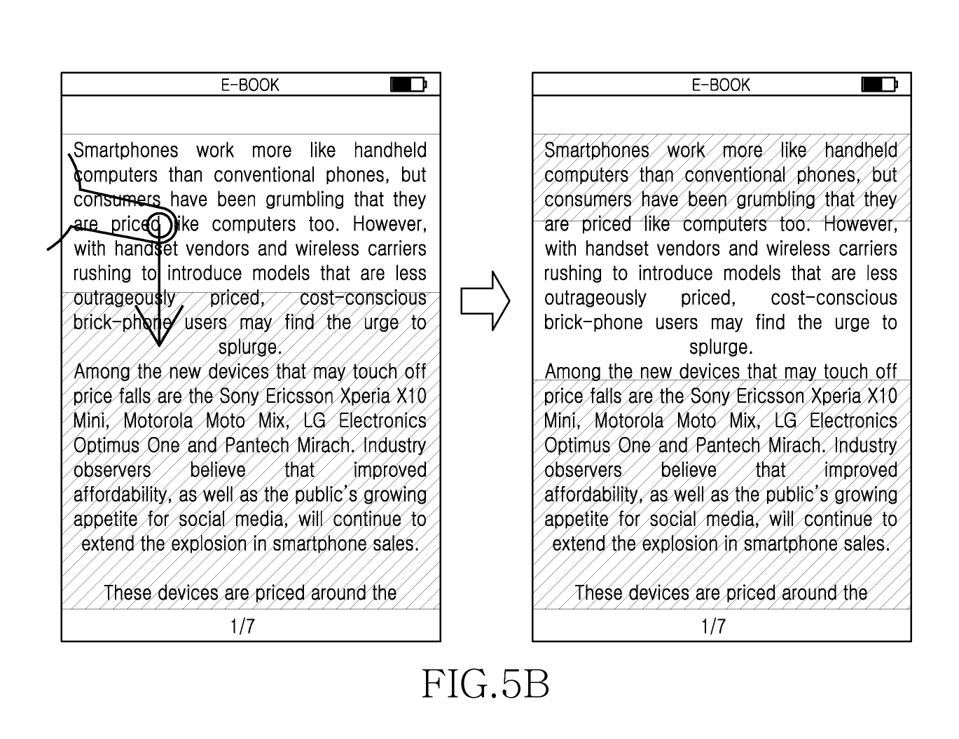

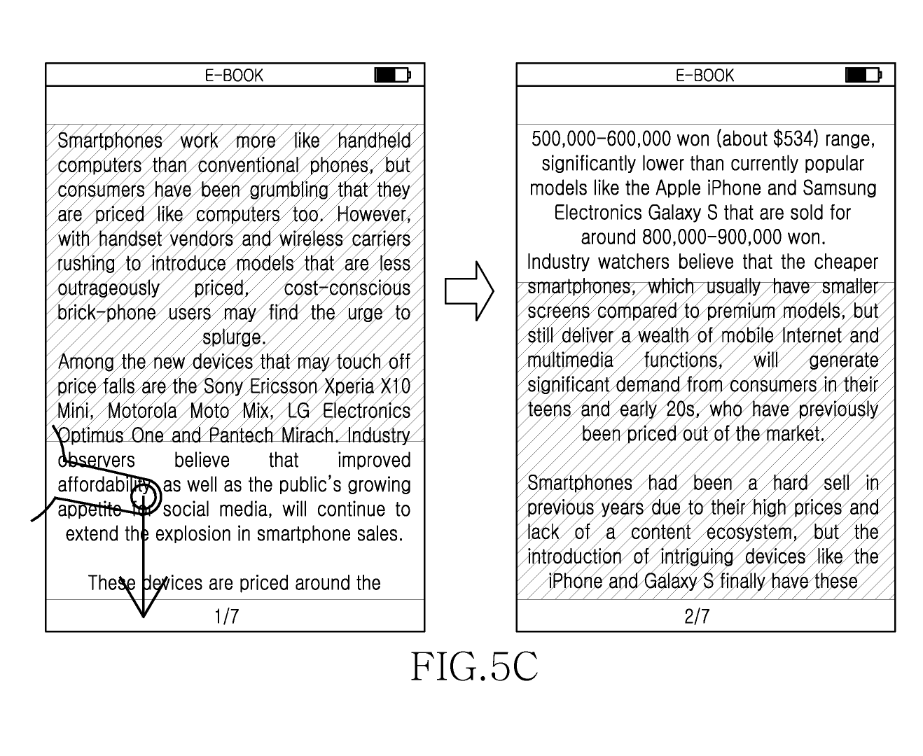

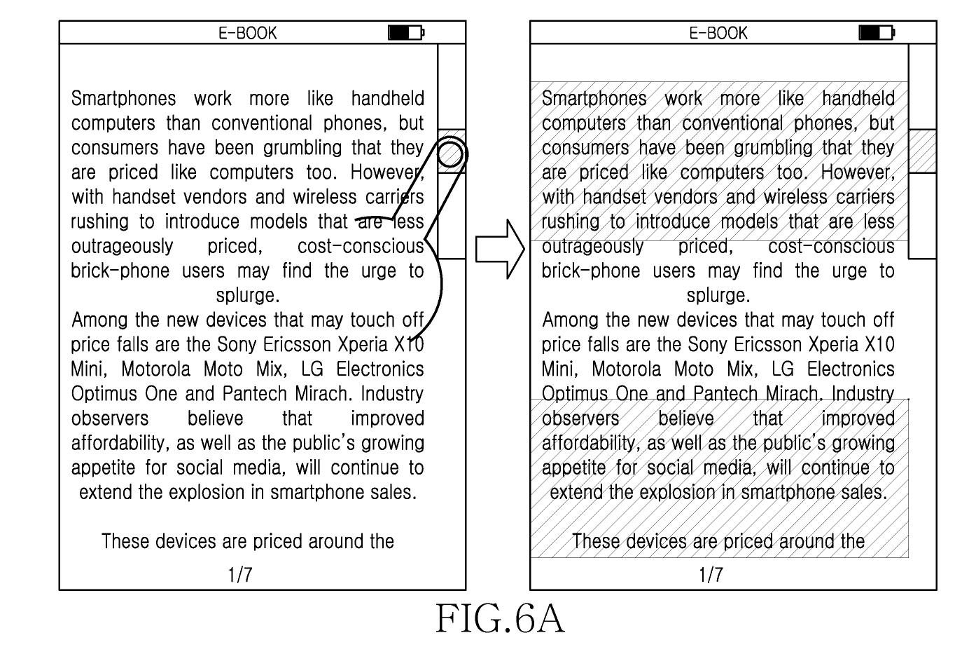

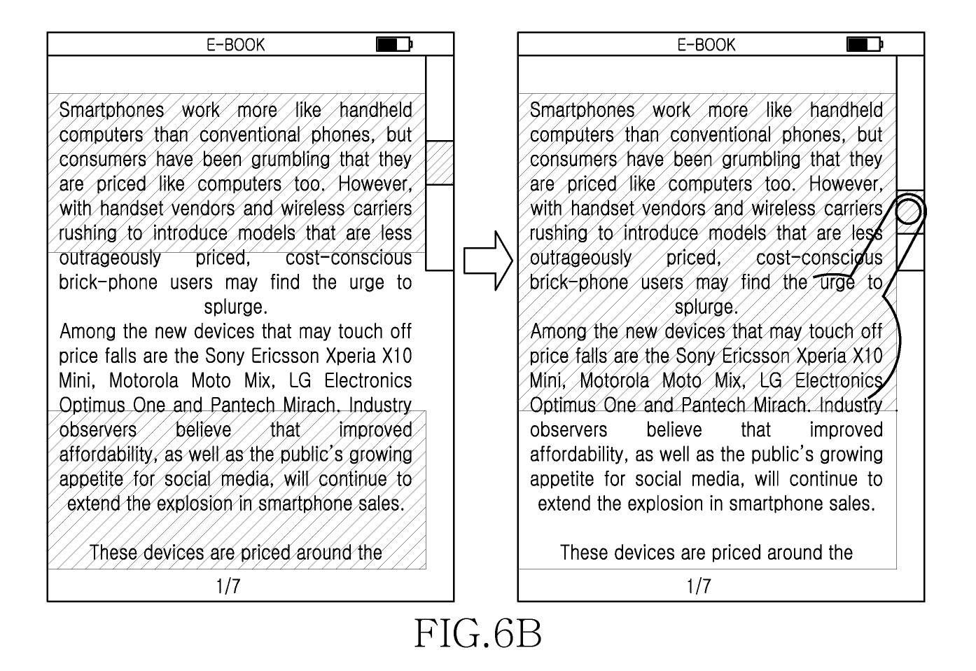

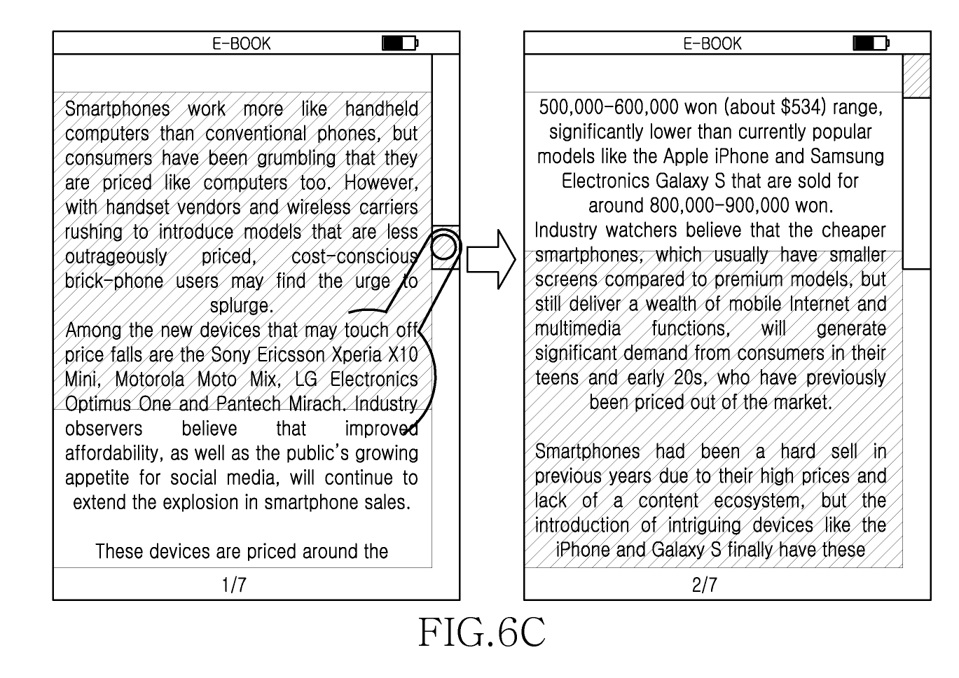

In addition, the controller 24 determines at step 413 whether or not a readable region release signal occurs. When the readable region release signal occurs, the controller 24 proceeds to perform step 415 to release the readable region and allow the entire screen to be displayed at a predetermined brightness, and then ends the power save mode. The readable region release signal may occur before/after the readable region is moved. An example of FIG. 4A will be described with reference to FIGS. 5A to 6C.

FIG. 4B is a flowchart illustrating a procedure for reducing power consumption in an E-book terminal having a self-emitting display according to an exemplary embodiment of the present invention.

Referring now to FIG. 4B, at step 417 the controller 24 determines whether a power save mode drive signal occurs during execution of an E-book. When the power save mode drive signal occurs, the controller 24 drives the power save mode and proceeds to perform step 419.

At step 419, the controller 24 displays a readable region occupying a 1/n of an entire screen vertical width on a current page screen and allows the brightness of the rest to be displayed darker than that of the readable region.

Next, at step 421 the controller 24 determines detection of one of a page turn signal, a downward (or upward) scroll signal, and no signal.

When determining the downward (upward) scroll signal in step 421, the controller 24 proceeds to step 423 to allow the readable region in the current page screen to be moved downward (or upward) and displayed. Next, the controller 24 proceeds to step 425 to determine whether a downward (or upward) scroll signal further occurs after the readable region in the current page screen is moved to the screen lower end (or upper end). When the downward (or upward) scroll signal occurs after the readable region in the current page screen is moved to the screen lower end (or upper end), the controller 24 turns to the next (or previous) page screen and allows the readable region to be displayed at the upper end (or lower end) of the turned next (or previous) page screen in step 427.

In addition, when determining the page switch (turn) signal in step 421, the controller 24 proceeds to step 427 to turn to the next (or previous) page screen and allow the readable region to be displayed at the upper end (or lower end) of the turned page screen.

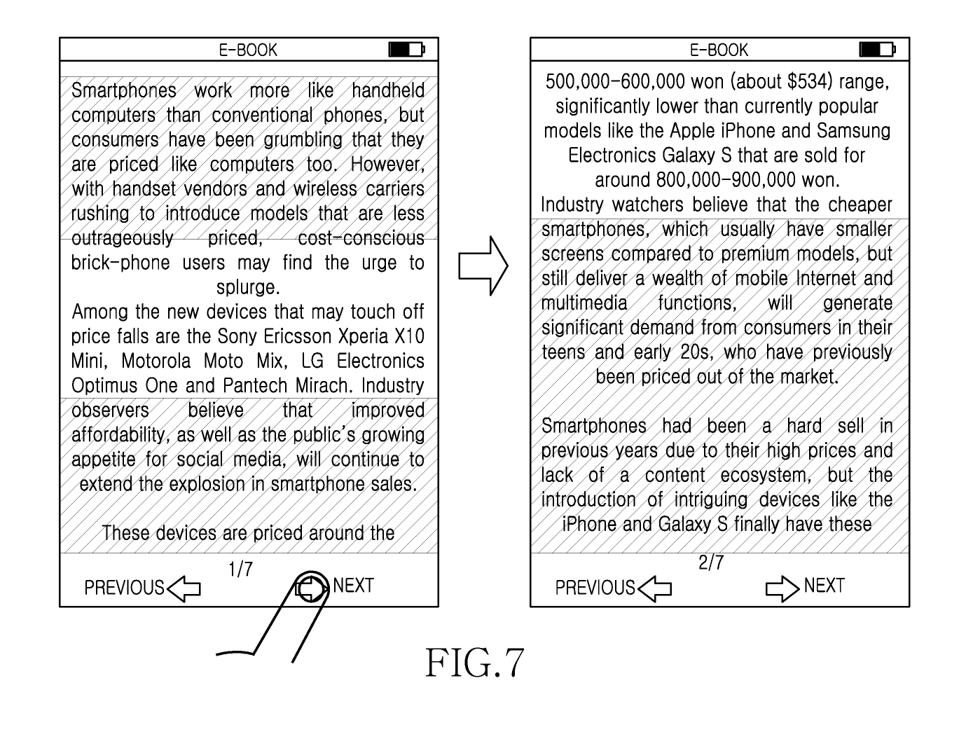

In addition, at step 429 the controller 24 determines whether or not a readable region release signal occurs. When the readable region release signal occurs, the controller 24 proceeds to perform step 431 to release the readable region and allow the entire screen to be displayed at a predetermined brightness, and then ends the power save mode. The readable region release signal may occur before/after the readable region is moved. An example of FIG. 4B will be described with reference to FIG. 7.

FIGS. 5A to 5C are views illustrating a process of a power save mode in an E-book terminal having a self-emitting display according to an exemplary embodiment of the present invention.

Referring now to FIG. 5A, a user touches a power save mode button provided to a touch region of a display screen during execution of an E-book to execute a power save mode. When the power save mode is executed, a readable region having a vertical width corresponding to 1/n (for example, ⅓, ¼, etc.) of the entire screen is displayed on a current page screen and the brightness of the rest is processed darker than that of the readable region as illustrated.

Referring now to FIG. 5B, when the user touches the readable region and moves the readable region downward, the readable region that has been located at the upper end initially is moved downward. The readable region may be moved, for example in proportion to a distance of the touch movement. Alternatively, it is possible to extend the brightened area of the display.

Referring now to FIG. 5C, when the readable region is moved to the lower end of the current page screen and then the user further performs the touch movement downward, the screen is turned to the next page screen and the readable region is displayed again at the upper end of the turned next page screen. Conversely, when the readable region is moved to the upper end of the current page screen and then the user further performs the touch movement upward, the screen is turned to the previous page screen and the readable region is displayed again at the lower end of the turned previous page screen.

FIGS. 6A to 6C are views illustrating a process of a power save mode in an E-book terminal having a self-emitting display according to an exemplary embodiment of the present invention.

Referring now to FIG. 6A, a user presses a scroll bar long provided to a touch region of a display screen during execution of an E-book, that is, presses the scroll bar for more than a threshold time after the touch to execute a power save mode. When the power save mode is executed, a readable region having a vertical width corresponding to 1/n (for example, ⅓, ¼, etc.) of the entire screen is displayed on a current page screen and the brightness of the rest is processed darker than that of the readable region as illustrated.

Referring now to FIG. 6B, when the user moves the scroll bar downward, the readable region is moved downward on a current page screen. The readable region may be moved in proportion to the touch movement distance.

Referring now to FIG. 6C, when the readable region is moved to the lower end of the current page screen and then the user moves the scroll bar downward further, the screen is turned to the next page screen, and the readable region is displayed again at the upper end of the turned next page screen. Conversely, when the readable region is moved to the upper end of the current page screen and then the user moves the scroll bar upward further, the screen is turned to the previous page screen and the readable region is displayed again at the lower end of the turned previous page screen.

FIG. 7 is a view illustrating a process of operating a power save mode and displaying a readable region as a page turns in an E-book terminal having a self-emitting display according to an exemplary embodiment of the present invention.

Referring now to FIG. 7, unlike the exemplary embodiment of FIGS. 5A to 6C, an exemplary embodiment of FIG. 7 provides a page turn button. A power save mode operates during execution of an E-book and a readable region is displayed on a current page screen, and the readable region may be moved using the method described in FIG. 5B. Furthermore, when a user touches the page turn button, the screen is turned to the next (or previous) page, and the readable region is displayed again on the turned page screen. That is, in the exemplary embodiment of FIGS. 5A to 6C, when the readable region is moved to the upper end or lower end of the screen and then the user further performs the scroll operation, a page turn occurs. In contrast, in the exemplary embodiment of FIG. 7, when the user presses the page turn button simply, a page is turned.

Furthermore, in the case where the E-book terminal has an acceleration sensor and may detect a slope, the movement of a readable region and a page screen turning corresponding to a slope direction may be facilitated. For example, when the lower end of the E-book terminal having the acceleration sensor is raised upward, a downward scroll signal occurs, so that the readable region is moved downward and then the screen may be turned to the next page screen on which the readable region is displayed. Furthermore, when the upper end of the E-book terminal having the acceleration sensor is raised upward, an upward scroll signal occurs, so that the readable region is moved upward and then the screen may be turned to the previous page screen on which the readable region is displayed. A velocity at which the readable region is moved may be proportional to a slope degree detected by the acceleration sensor.

In addition, when the acceleration sensor is used, the above-described page screen turning in FIG. 7 is possible. For example, when the lower end of the E-book terminal having the acceleration sensor is raised upward twice, the screen may be immediately turned to the next page.

Generally, since a user holds the terminal up at different angles and views the screen, the user detects the slope at the point where user turns over the page screen and the slope stops to move the readable region or turn the page screen.

Consequently, exemplary embodiments of the present invention may reduce power consumption without reducing readability when a user views contents such as a web page, an E-book, etc.

The above-described methods according to the present invention can be implemented in hardware, firmware or as software or computer code that can be stored in a recording medium such as a CD ROM, an RAM, a floppy disk, a hard disk, thumbnail drive or a magneto-optical disk or computer code downloaded over a network originally stored on a remote recording medium or a non-transitory machine readable medium and to be stored on a local non-transitory recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for reducing power consumption in a terminal having a self-emitting display, the method comprising:
displaying a readable region on a display screen and making a brightness of the rest darker than that of the readable region; and
moving display of the readable region by a controller in response to a relevant signal, wherein an area of the readable region is less than a viewable area of an entire display screen.

2. The method of claim 1, wherein the relevant signal occurs from a sensing of contact on the screen that comprises scrolling in a predetermined direction.

3. The method of claim 1, further comprising the controller releasing the readable region and displaying an entire display screen at a predetermined brightness.

4. The method of claim 1, further comprising, when the controller detects a screen turn, displaying the readable region on the turned screen again.

5. The method of claim 4, wherein the screen turns comprise one of a page turn or turn signal.

6. The method of claim 1, further comprising the controller controlling a size of the readable region.

7. A method for reducing power consumption in an Electronic (E)-book terminal having a self-emitting display, the method comprising:
displaying by a display a readable region on a current page screen in which an area of the readable region is less than an area of an entire current page screen, and rendering by a controller a brightness of a rest of the current page screen being displayed darker than that of the readable region; and
moving display of the readable region on the current page screen along the display in accordance with a user-selection.

8. The method of claim 7, further comprising in response to an input by a user, releasing the readable region and displaying an entire current page screen at a predetermined brightness.

9. The method of claim 7, further comprising, when the display of the current page screen turns to a next or previous page screen, displaying the readable region again on the next or previous page screen.

10. The method of claim 7, further comprising the controller controlling a size of the readable region according to a changeable default.

11. The method of claim 7, wherein the readable region occupies 1/n of an entire screen vertical width, in which n is greater than or equal to 1.

12. The method of claim 11, further comprising, when display of the readable region is moved further downward via user contact after the readable region has been moved to a lowermost end of the current page screen being displayed, turning display of the current page screen to a next page screen, and displaying the readable region again at an upper end of the next page screen.

13. The method of claim 11, further comprising, when display of the readable region is moved further upward via user contact after the readable region has been moved to an uppermost end of the current page screen being displayed, turning display of the current page screen to a previous page screen, and displaying the readable region at a lower end or predetermined portion of the of the previous page screen.

14. An apparatus for reducing power consumption in a terminal having a self-emitting display screen, the apparatus comprising:
a memory unit for storing an object data;
a display unit for decoding data stored in the memory unit and outputting a display according to an image signal;
an input unit for receiving a user input; and
a controller for performing an overall control of an operation of the terminal,
wherein when the controller detects when a power save mode signal is received from the input unit, the controller displays a movable readable region on an area of the display screen being less than an entire viewable area of the display unit, and the controller renders a brightness of the rest of the darker than that of the readable region.

15. The apparatus of claim 14, wherein when the controller detects a readable region release signal is received from the input unit, the controller releases the readable region and displays an entire viewable area of the display screen display at a predetermined brightness.

16. The apparatus of claim 14, wherein when the controller detects a scroll signal is received from the input unit, the controller moves display of the readable region to a relevant direction corresponding to a direction of a motion of the scroll.

17. The apparatus of claim 14, wherein when the controller detects a screen turn page signal is received from the input unit, the controller turns the current screen page and displays the readable region again on the turned screen page.

18. The apparatus of claim 14, wherein the display further includes an acceleration sensor for detecting a slope of the terminal being moved, and
wherein the controller moves display of the readable region to a relevant direction depending on a slope direction detected by the acceleration sensor, and moves the readable region at a relevant velocity depending on a slope degree detected by the acceleration sensor.
